(19) United States
(12) Patent Application Publication
(10) Pub. No.: US 2007/0136977 A1
(43) Pub. Date: Jun. 21, 2007

(54) Particle removing apparatus for cleaning dust-free clothes

(75) Inventors: Chieh Ming Lin, Miao-Li (TW); Hao Chung Ko, Miao-Li (TW); Wen Neng Tseng, Miao-Li (TW); Chien Sung Deng, Miao-Li (TW); Hung Wen Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,258

(22) Filed: Dec. 19, 2006

(30) Foreign Application Priority Data
Dec. 20, 2005 (CN) 200520120944.9

(51) Int. Cl. B08B 5/04

(52) U.S. Cl. 15/303

(57) ABSTRACT

An exemplary particle removing apparatus includes a main body (10) having a chamber (11); a hollow roller (12) being capable of rotating in the chamber, the roller includes an air inlet (123) and a rear portion (124) opposite to the air inlet; a first motor (14) for driving the roller to rotate about a rotational axis thereof; an agitator (13) located in the roller, the agitator being capable of rotating in the roller, and spanning at least most of a distance from the air inlet to the rear portion; and an air feeding unit (20) connecting with the chamber for introducing air into the roller via the air inlet.

### FIELD OF THE INVENTION

The present invention relates to particle removing apparatus, and especially to a particle removing apparatus for cleaning anti-dust clothing.

### BACKGROUND

Generally, a large number of dust-free clothes are worn by workers in clean rooms in the semiconductor industry and related industries. These clothes are made of special materials that resist contamination.

Nowadays, the semiconductor industry makes chips with very high levels of circuit integration. Some of the wafers made may also be particularly thin. In addition, the manufacturing of some product components such as LCDs (liquid crystal displays) also requires clean rooms. Some modern LCDs are large, and great care is needed to keep them uncontaminated. Thus the level of cleanliness required in clean rooms is becoming increasingly stringent. Finding a way of lower the quantity and the cost of dust-free clothes is therefore becoming increasingly important.

### SUMMARY

An exemplary particle removing apparatus includes a main body having a chamber; a hollow roller being capable of rotating in the chamber, the roller includes an air inlet and a rear portion opposite to the air inlet; a first motor for driving the roller to rotate about a rotational axis thereof; an agitator located in the roller, the agitator being capable of rotating in the roller, and spanning at least most of a distance from the air inlet to the rear portion; and an air feeding unit connecting with the chamber for introducing air into the roller via the air inlet.

Another exemplary particle removing apparatus includes a main body having a chamber; a roller capable of rotating in the chamber, the roller comprising an air inlet and a rear portion opposite to the air inlet; an agitator extended from the rear portion to the air inlet of the roller; a motor coupled to the agitator for driving the agitator to rotate about a rotational axis; and an air feeding unit connecting with the chamber for introducing air into the roller via the air inlet.

Other advantages and novel features will become more apparent from the following detailed description of preferred embodiments when taken in conjunction with the accompanying drawings. In the drawings, all the views are schematic.

### BRIEF DESCRIPTION OF THE DRAWINGS

FIG. 1 is a side, cross-sectional view of a particle removing apparatus according to an exemplary embodiment of the present invention, the particle removing apparatus including a hollow roller and an agitator in the hollow roller.

FIG. 2 shows two front end views of the hollow roller of the particle removing apparatus of FIG. 1, illustrating cleaning of dust-free clothes in the hollow roller by operation of the particle removing apparatus.

### DETAILED DESCRIPTION OF PREFERRED EMBODIMENTS

Reference will now be made to the drawings to describe the preferred embodiments in detail.

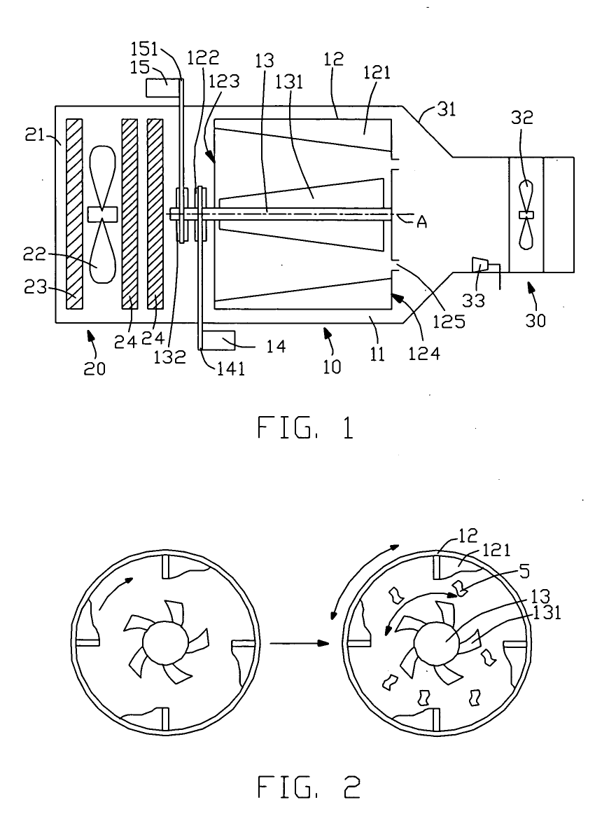

FIG. 1 is a side, cross-sectional view of a particle removing apparatus according to an exemplary embodiment of the present invention. The particle removing apparatus includes a main body 10, an air feeding unit 20, and an air discharging unit 30.

The main body 10 includes a chamber 11, and a hollow roller 12 capable of rotating in the chamber 11 about the rotational axis A. The hollow roller 12 includes an air inlet 123, and a rear portion 124 opposite to the air inlet 123. The rear portion 124 includes a plurality of through holes 125 for discharging air. The hollow roller 12 further includes a plurality of first blades 121 disposed on an inner wall thereof. Each first blade 121 is oriented along a direction parallel to the rotational axis A, and spans a full length of the hollow roller 12. A maximum radial width of each first blade 121 gradually increases from the end near the air inlet 123 to the opposite end near the rear portion 124. Further, referring also to FIG. 2, each first blade 121 has a curved body that generally tapers toward a clockwise end thereof.

The main body 10 also includes an agitator 13 disposed in a middle portion of the hollow roller 12. The agitator 13 spans substantially from the air inlet 123 to the rear portion 124, and is also capable of rotating about the rotational axis A. The agitator 13 includes a plurality of second blades 131 extending from a main axle thereof. A radial width of each second blade 131 also gradually increases from the end near the air inlet 123 to the opposite end near the rear portion 124. Referring also to FIG. 2, each second blade 131 can be involute.

The main body 10 further includes two motors 14 and 15, for driving the hollow roller 12 and the agitator 13 respectively. The motor 14 is coupled to a wheel 122 near the air inlet 123 of the hollow roller 12 via a belt 141, for driving the hollow roller 12 to rotate about the rotational axis A. The motor 15 is coupled to a wheel 132 of the agitator 13 via a belt 151, for driving the agitator 13 to rotate about the rotational axis A. The motors 14 and 15 are controlled by a motor controlling unit (not shown), which can adjust rotation speeds and rotation directions of the motors 14 and 15. In addition, the motors 14 and 15 may be equipped with deceleration units in order to adjust rotation speeds and rotation directions of the motors 14 and 15.

The air feeding unit 20 includes an air feeding passage 21 connecting with the chamber 11, an air feeding fan 22 disposed in the air feeding passage 21 for introducing air from the ambient environment into the hollow roller 12 via the air feeding passage 21, an air filter 23, and a pair of air filters 24. The air filter 23 is disposed at a front side of the air feeding fan 22. The air filter 23 has a lower density, and is used for filtering particles with a large diameter. The air filters 24 are disposed at a rear side of the air feeding fan 22. Each air filter 24 can be a high efficiency particulate air filter. The quantity of air filters 24 employed may be varied to ensure that the air introduced into the roller 12 matches with applicable cleaning standard requirements. In the illustrated embodiment, two high efficiency particulate air filters 24 are disposed at the rear side of the air feeding fan 22.

The air discharging unit 30 includes an air discharging passage 31 connecting with the chamber 11 and with the hollow roller 12 via the through holes 125, and an air discharging fan 32 disposed in the air discharging passage 31 for discharging air from the chamber 11 and the hollow roller 12. The air discharging unit 30 includes a frustum-shaped portion connecting with the main body 10, and a cylindrical portion distal from the main body 10. A diameter of the cylindrical portion is less than a diameter of the main body 10. A particle sensor 33 is disposed at an inner wall of the air discharging passage 31 at the cylindrical portion of the air discharging unit 30, for detecting particles in the air being discharged. The particle sensor 33 measures an amount of dust in the air being discharged, and can provided a corresponding readout for an operator.

FIG. 2 is a schematic view of an operation of cleaning dust-free clothes in the roller 12 of the particle removing apparatus. Both the roller 12 and the agitator 13 can rotate about a clockwise or anti-clockwise direction. That is, the roller 12 and the agitator 13 may be rotated in the same direction or in opposite directions according to requirements. The roller 12 and the agitator 13 can thus rotate to remove any particles on the dust-free clothes 5 in the roller 12 via physical contact and via movement in the air induced during the rotation process.

The quantity of the first and second blades 121 and 131 is not limited to the quantity shown in the drawings. The number of first and second blades 121 and 131 can be configured according to particular cleaning requirements.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A particle removing apparatus, comprising:
a main body having a chamber;
a hollow roller being capable of rotating in the chamber, the roller comprising an air inlet and a rear portion opposite to the air inlet;
a first motor for driving the roller to rotate about a rotational axis thereof;
an agitator located in the roller, the agitator being capable of rotating in the roller, and spanning at least most of a distance from the air inlet to the rear portion; and
an air feeding unit connecting with the chamber for introducing air into the roller via the air inlet.

2. The particle removing apparatus as claimed in claim 1, wherein the first motor drives the roller via a first belt.

3. The particle removing apparatus as claimed in claim 2, further comprising a second motor and a second belt, wherein the second motor is configured for driving the agitator to rotate about the rotational axis via the second belt.

4. The particle removing apparatus as claimed in claim 3, wherein the roller and the agitator rotate in the same direction.

5. The particle removing apparatus as claimed in claim 3, wherein the roller and the agitator rotate in opposite directions.

6. The particle removing apparatus as claimed in claim 1, wherein the roller further comprises a plurality of blades each of which extends from an end of the roller at the air inlet to an end of the roller at the rear portion.

7. The particle removing apparatus as claimed in claim 6, wherein a maximum radial width of each of the blades gradually increases from the end of the roller at the air inlet to the end of the roller at the rear portion.

8. The particle removing apparatus as claimed in claim 1, wherein the agitator comprises a plurality of blades each of which extends from an end of the roller at the air inlet to an end of the roller at the rear portion, and a maximum radial width of each of the blades gradually increases from the end of the roller at the air inlet to the end of the roller at the rear portion.

9. The particle removing apparatus as claimed in claim 1, wherein the rear portion of the roller has a plurality of through holes defined therein.

10. The particle removing apparatus as claimed in claim 1, wherein the air feeding unit comprises an air feeding passage connecting with an end of the chamber, an air feeding fan disposed in the air feeding passage and configured for introducing air into the roller via the air feeding passage, and a plurality of air filters selectively disposed at both of a side of the air feeding fan nearest the chamber and a side of the air feeding fan distal most from the chamber.

11. The particle removing apparatus as claimed in claim 1, further comprising an air discharging unit connecting with an end of the chamber.

12. The particle removing apparatus as claimed in claim 11, wherein the air discharging unit comprises an air discharging passage connecting with the chamber, and an air discharging fan disposed in the air discharging passage, the air discharging fan configured for facilitating discharge of air from the chamber.

13. The particle removing apparatus as claimed in claim 12, further comprising a particle sensor disposed at an inner wall of the air discharging passage.

14. A particle removing apparatus, comprising:
a main body having a chamber;
a hollow roller capable of rotating in the chamber, the roller comprising an air inlet and a rear portion opposite to the air inlet;
an agitator extended from the rear portion to the air inlet of the roller;
a motor coupled to the agitator for driving the agitator to rotate about a rotational axis thereof; and
an air feeding unit connecting with the chamber for introducing air into the roller via the air inlet.

15. The particle removing apparatus as claimed in claim 14, wherein the agitator comprises a plurality of blades.

16. The particle removing apparatus as claimed in claim 15, wherein maximum radial width of the blade gradually increases from an end near the air inlet to an opposite end near the rear portion of the roller.

17. A particle removing apparatus, comprising:
a main body having a chamber;
a hollow roller being capable of rotating in the chamber, the roller being configured to allow air to pass therethrough in an axial direction thereof;
a plurality of first blades formed on an inner surface of the hollow roller;
an agitator located in the roller, the agitator being capable of rotating in the roller;
a plurality of second blades formed on an outer surface of the agitator; and
an air feeding unit connecting with the chamber to force the air to enter the chamber.

18. The particle removing apparatus as claimed in claim 17, wherein the first blades and the second blades are arranged in complementary configurations and positions.
